(19) United States
(12) Patent Application Publication
(10) Pub. No.: US 2016/0284286 A1
(43) Pub. Date: Sep. 29, 2016

(54) DISPLAY UNIT

(71) Applicant: FANUC Corporation, Minamitsuru-gun (JP)

(72) Inventor: Hiroyuki MARUYAMA, Minamitsuru-gun (JP)

(21) Appl. No.: 15/078,312

(22) Filed: Mar. 23, 2016

(30) Foreign Application Priority Data
Mar. 27, 2015 (JP) 2015-065701

(51) Int. Cl. G09G 3/36

(52) U.S. Cl. CPC G09G 3/36; G09G 2340/0407; G09G 2330/12

(57) ABSTRACT

Disclosed is a display unit provided with a backlight on the reverse side of a display panel, a display controller with a circuit configured to generate a display signal for display by the display panel, backlight power consumption acquisition unit for acquiring information on the power consumption of a power supply for the backlight, identification unit for identifying the size of the display panel based on the information on the power consumption of the backlight acquired by the backlight power consumption acquisition unit, and storage unit stored with a set value for the generation of a display signal corresponding to the size of the display panel. The set value for the generation of the display signal is read from the storage unit and set in the display controller, based on the display panel size identified by the identification unit. Thus, a display control printed circuit board can be shared in common without regard to the display panel size.

### BACKGROUND OF THE INVENTION

1. Field of the Invention

The present invention relates to a display unit.

2. Description of the Related Art

As described in Japanese Patent Application Laid-Open No. 2011-203399, a display unit that combines a display panel and a control circuit for controlling the display panel is based on a well-known technique.

As shown in FIG. 1, a display panel 10 comprises a light source (LED backlight) 2 and a liquid-crystal panel 3 (including a light guide plate 4, polarizing filter 5, array substrate 6, liquid crystal 7, common transparent electrode 8, and color filter 9).

In the display panel 10, light emitted from the light source 2 of the LED backlight is passed through the liquid-crystal panel 3 so that it is partially intercepted or transmitted for a color or contrast display. The liquid-crystal panel 3 must be driven in order to partially intercept the light or allows it to be transmitted, so that the display panel 10 is mounted with a drive control circuit for driving the liquid-crystal panel 3.

Input signals for the drive control circuit vary in specifications (resolution (number of pixels displayed on a screen), dot clock (clock as a reference for transfer per pixel), horizontal scanning frequency (updated number of lines capable of being displayed in each second), and vertical scanning frequency (number of screens updated in each second)), depending on the size of the display panel 10. In general, therefore, the setting of a display controller for controlling the drive control circuit is changed for the display depending on the size.

Further, a current source for the light source 2 of the LED backlight is based on a constant-current or -voltage circuit as a power supply circuit. As shown in FIG. 2, a display unit 1 comprises the display panel 10, a display control printed circuit board 11, and a fixing metal plate 20 for securing them to each other. The printed circuit board 11 serves to control a display signal to be transmitted to the display panel 10 and the light source 2 of the backlight. The illustration of a housing part of the display unit 1 is omitted.

The display control printed circuit board 11 is mounted with a display controller 12 for generating a display control signal, a central processing unit (CPU) 13 for setting the display controller 12, a memory 14 stored with set values for the display panel 10, and an LED backlight power supply circuit 15.

The display signal generated by the display control printed circuit board 11 is transmitted from a display signal connector 16 of the printed circuit board 11 to the display panel 10 by a display signal cable 17 (see numeral 24 in FIG. 3). LED backlight power generated by the printed circuit board 11 is supplied from an LED backlight connector 18 to the display panel 10 by an LED backlight cable 19 (see numeral 25 in FIG. 3).

The display panel 10 varies in the resolution (number of pixels displayed on a screen), dot clock (clock as a reference for transfer per pixel), horizontal scanning frequency (updated number of lines capable of being displayed in each second), and vertical scanning frequency (number of screens updated in each second), depending on its size. For correct display, therefore, it is necessary to generate the display signal conforming to the specifications of the display panel 10 and send it to the display panel 10. A correct display cannot be obtained if the display signal does not conform to the specifications of the display panel 10.

FIG. 3 shows a configuration and processing of the display control printed circuit board 11. The CPU 13 reads identification information (hereinafter referred to as “ID”) of the display panel 10 (numeral 21), reads a set value corresponding to the ID from the memory 14 (numeral 22), and sets the resolution, dot clock, horizontal scanning frequency, vertical scanning frequency, and the like for the display controller 12 (numeral 23). The display controller 12 generates the display signal according to the set value and transmits it to the display panel 10 (numeral 24).

Since the display panel 10 does not have its own ID, the CPU 13 cannot read any ID of the display panel 10 from the display signal connector 16 of FIG. 1. Instead, a circuit for identifying the ID of the display panel 10 should be mounted on the display control printed circuit board 11 so that the CPU 13 can read the ID. In this case, types required for the printed circuit board 11 are as many as those for the display panel 10 to be combined therewith. If a large number of types are provided for the printed circuit board 11, the manufacture requires production control based on the types for the display unit 1 to be shipped. In assembling the display unit 1, moreover, the printed circuit board 11 may possibly be used in a wrong manner. At the time of maintenance, the printed circuit board 11 varies depending on the size of the display panel 10 of the display unit 1, so that the number of maintenance parts increases. In some cases, furthermore, the printed circuit board 11 may be wrongly used at the time of replacement.

### SUMMARY OF THE INVENTION

Accordingly, the object of the present invention is to provide a display unit in which a display control printed circuit board can be shared in common without regard to the size of a display panel.

A display unit according to the present invention is provided with a backlight on the reverse side of a display panel and a display controller with a circuit configured to generate a display signal for display by the display panel, and comprises power consumption acquisition unit for acquiring information on the power consumption of a power supply for the backlight, identification unit for identifying the size of the display panel based on the information on the power consumption of the backlight acquired by the backlight power consumption acquisition unit, and storage unit stored with a set value for the generation of a display signal corresponding to the size of the display panel. The set value for the generation of the display signal is read from the storage unit and set in the display controller, based on the display panel size identified by the identification unit.

According to the present invention, there can be provided a display unit in which a display control printed circuit board can be shared in common without regard to the size of a display panel.

Further, the information on the power consumption of the backlight may be a physical quantity obtained by a measuring resistor attached to the power supply for the backlight or a physical quantity obtained by a current sensor attached to the power supply for the backlight.

### BRIEF DESCRIPTION OF THE DRAWINGS

The above and other objects and features of the present invention will be obvious from the ensuing description of embodiments with reference to the accompanying drawings, in which:

FIG. 1 is a view showing a configuration of a display panel;

FIG. 2 is a view illustrating a display unit;

FIG. 3 is a functional block diagram of a conventional display control printed circuit board;

FIG. 4 is a functional block diagram of a control printed circuit board according to the present invention;

FIG. 5 is a diagram illustrating a measurement method for a backlight current value; and

FIG. 6 is a diagram illustrating another measurement method for the backlight current value.

### DETAILED DESCRIPTION OF THE PREFERRED EMBODIMENTS

An embodiment of the present invention will now be described with reference to the accompanying drawings. Like reference numerals are used to designate the same or similar configurations as those of the prior art.

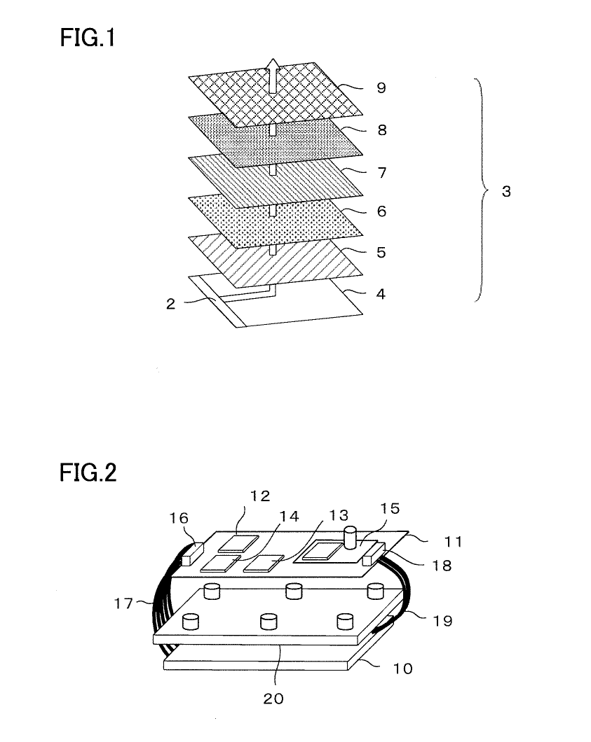

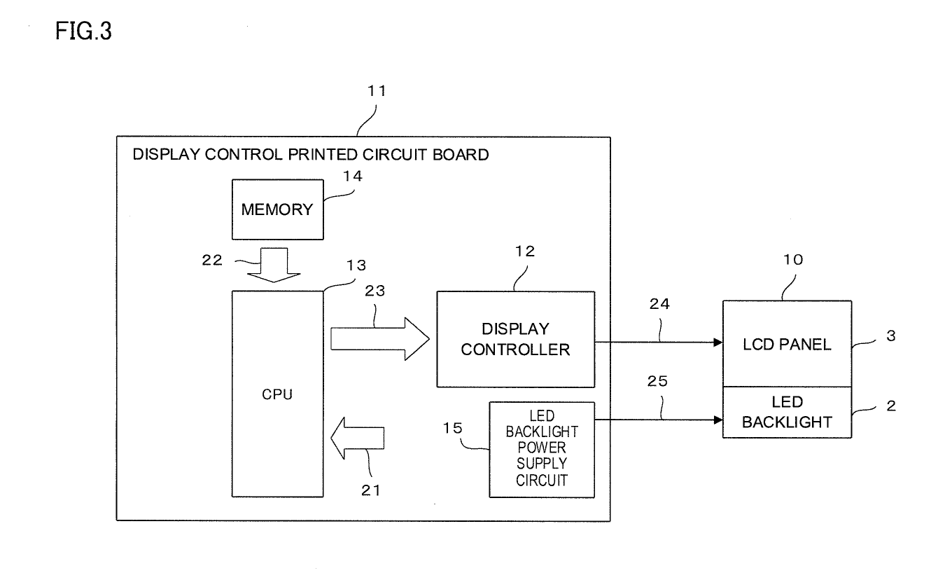

As shown in FIG. 1, a display panel 10 comprises a light source (backlight) 2, light guide plate 4, polarizing filter 5, array substrate 6, liquid crystal 7, common transparent electrode 8, and color filter 9. In recent years, a low-consumption LED has been frequently used as a backlight that serves as the light source 2. Since the consumption current of the LED backlight greatly varies depending on the size of the display panel 10, the display panel size can be identified by obtaining information on the power consumption of the backlight.

In the display panel 10 using the LED backlight, the backlight consumption current, which is the information on the power consumption of the backlight, greatly varies depending on the size of the display panel 10. In order to solve problems of the present invention, the consumption current of the LED backlight, which greatly varies depending on the display panel 10, is measured, and the display panel size is identified based on the result of the measurement. Thus, a display control printed circuit board can be shared in common without regard to the display panel size.

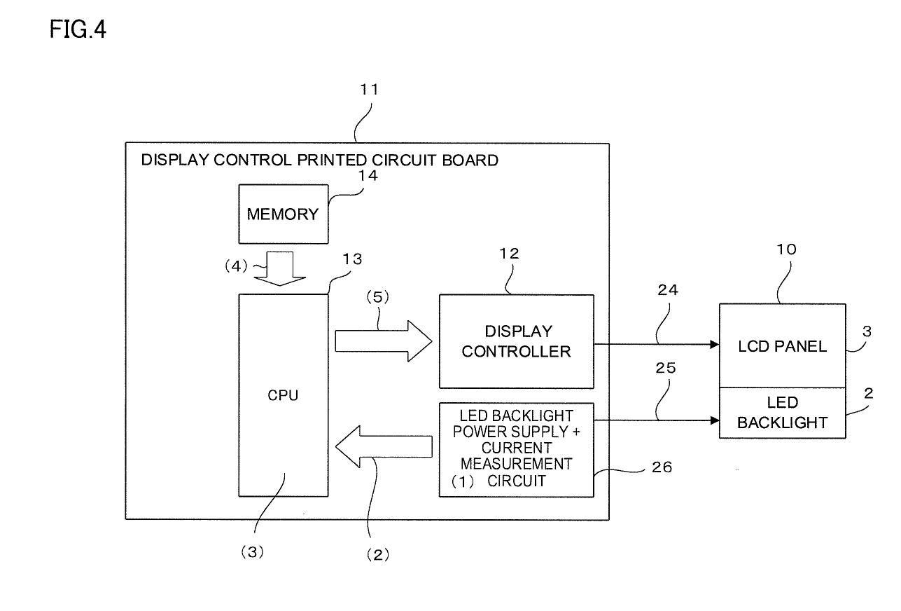

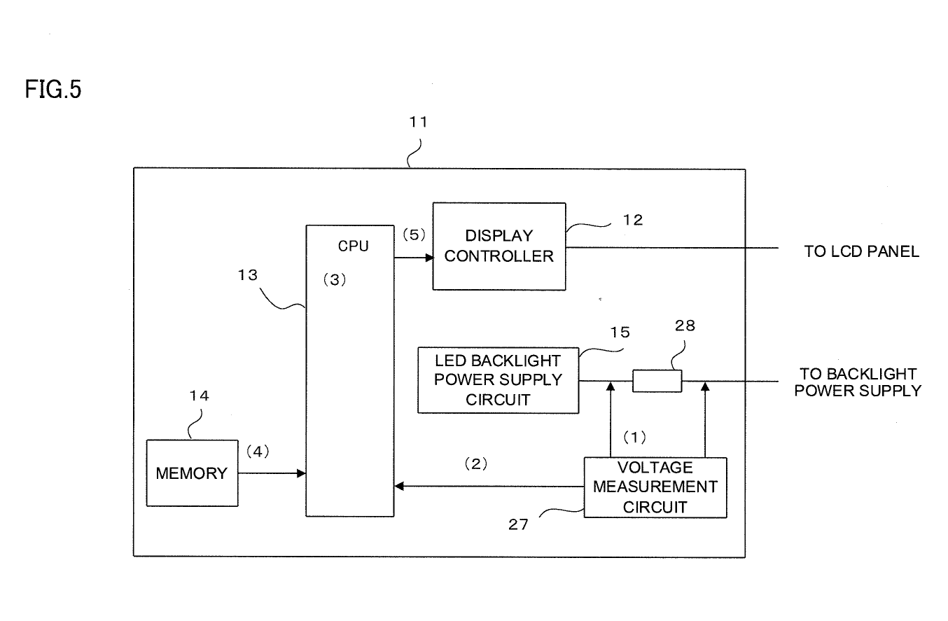

The following is a description of verification procedure. FIG. 4 is a functional block diagram of a control printed circuit board according to the present invention.

(1) After a device is powered on, an LED backlight current measurement circuit 26 on a display control printed circuit board 11 measures the consumption current of the LED backlight (light source 2).

(2) The current measurement circuit outputs the result of the current measurement to a CPU 13.

(3) The CPU 13 identifies the display panel size based on a measured value obtained by the current measurement circuit 26.

(4) The CPU 13 reads an identified set value of the display panel from a memory 14.

(5) The CPU 13 sets the set value read from the memory 14 in a display controller 12.

FIG. 5 shows a case in which a measurement method for a backlight current value is applied to the measurement of voltage across a measuring resistor. The measuring resistor is connected in series with a wiring pattern for the supply voltage that is output to the backlight.

(1) A current is applied to the backlight and voltage across a measuring resistor 28 is measured by a voltage measurement circuit 27.

(2) The value of the measured voltage is converted (by A/D conversion and the like) to data that can be read by the CPU 13, and the result of the measurement is transmitted to the CPU 13.

(3) The CPU 13 reads contrast data on the voltage value and the display panel size from the memory 14, compares the contrast data and the measurement result of item (2), and determines the display panel size.

(4) The CPU 13 reads the identified set value of the display controller 12 for the display panel from the memory 14.

(5) The display controller 12 is set.

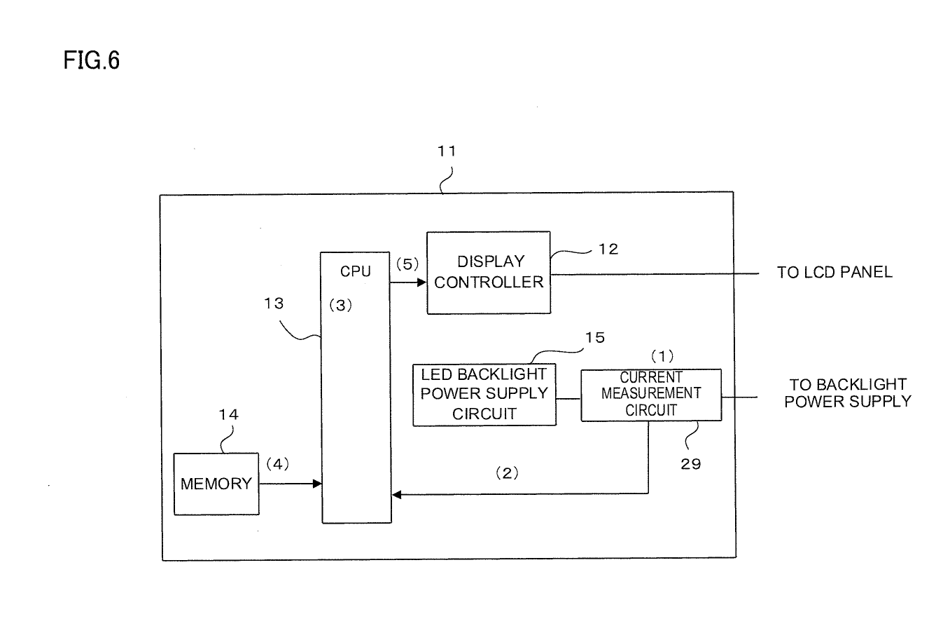

FIG. 6 shows a case in which the measurement method for the backlight current value is applied to a measurement using a current sensor IC. A current measurement circuit comprising the current sensor IC is connected in series with a power supply pattern that is output to the backlight.

(1) A current is applied to the backlight and the consumption current is measured by a current measurement circuit 29.

(2) The value of the measured current is converted (by A/D conversion and the like) to data that can be read by the CPU 13, and the result of the measurement is transmitted to the CPU 13.

(3) The CPU 13 reads contrast data on the voltage value and the display panel size from the memory 14, compares the contrast data and the measurement result of item (2), and determines the display panel size.

(4) The CPU 13 reads the identified set value of the display controller 12 for the display panel from the memory 14.

(5) The display controller 12 is set.

While an embodiment of the present invention has been described herein, the invention is not limited to the above-described embodiment and may be suitably modified and embodied in various forms.

1. A display unit which comprises a backlight on the reverse side of a display panel and a display controller with a circuit configured to generate a display signal for display by the display panel, the display unit comprising:
backlight power consumption acquisition unit for acquiring information on the power consumption of a power supply for the backlight;
identification unit for identifying the size of the display panel based on the information on the power consumption of the backlight acquired by the backlight power consumption acquisition unit; and
storage unit stored with a set value for the generation of a display signal corresponding to the size of the display panel,
wherein the set value for the generation of the display signal is read from the storage unit and set in the display controller, based on the display panel size identified by the identification unit.

2. The display unit according to claim 1, wherein the information on the power consumption of the backlight is a physical quantity obtained by a measuring resistor attached to the power supply for the backlight or a physical quantity obtained by a current sensor attached to the power supply for the backlight.
